(19) United States
(12) Patent Application Publication
(10) Pub. No.: US 2026/0184574 A1
(43) Pub. Date: Jul. 2, 2026

(54) SELECTIVE LASER HEATING OF CARBON NANOTUBES IN THE PRESENCE OF CARBON-BASED PRECURSORS

(71) Applicant: Battelle Memorial Institute, Columbus, OH (US)

(72) Inventors: Krenar SHQAU, Westerville, OH (US); Erica S. HOWARD, Upper Arlington, OH (US); James E. RISSER, Luthervile Timonium, MD (US); Amy Marie HEINTZ, Pacific Grove, CA (US); Thomas Morton HAMNER, Plain City, OH (US); Albert J. DARLING, Bexley, OH (US)

(21) Appl. No.: 19/436,098

(22) Filed: Dec. 30, 2025

Related U.S. Application Data
(60) Provisional application No. 63/739,847, filed on Dec. 30, 2024.

(51) Int. Cl. C01B 32/205; B33Y 10/00; B33Y 70/00

(52) U.S. Cl. CPC C01B 32/205; B33Y 10/00; B33Y 70/00

(57) ABSTRACT

Selective laser heating of carbon nanotubes in the presence of carbon-based precursors. The method involves supplying carbon nanotubes, supplying a carbon-based precursor composed of up to 15 carbon atoms along with hydrogen atoms, forming a mixture of the carbon nanotubes with the carbon-based precursor and applying selective laser heating to the mixture and graphitizing the carbon-based precursor.

### FIELD

The present invention stands directed at selective laser heating of carbon nanotubes in the presence of carbon-based precursors.

### BACKGROUND

Carbon nanotubes (CNTs) are generally understood as hollow cylindrical structures composed of carbon atoms, with diameters measured in nanometers. CNTs have been identified for use in a variety of applications, such as nanoelectronics, drug delivery systems, energy storage devices, and sensors. CNTs therefore have been proposed as a potential alternative to conventional metal electrical conductors.

However, CNT electrical conductivity has been observed to have electrical conductivity losses. In particular, electrical conductivity of extended CNT structures is lowered by what is described as relatively high contact resistance. That is, despite the relatively high intrinsic electrical conductivity of individual CNTs, the electrical current flow is hindered at the junctions between extended CNTs due to relatively poor contact, limiting the extended CNT material's effective conductivity. Such relatively poor contact between CNTs can be attributed to misalignments, voids, and impurities at the inter-tube connection locations thereby providing a relatively high energy barrier for electron transport.

Accordingly, a need remains to provide extended CNT structures with relatively low contact resistance by creating more effective electron transport pathways between neighboring CNT, resulting in improved electrical conductivity. This is then contemplated to expand the application of such CNTs in a variety of electronic components, such as conductors, transistors, conductive films, electrodes, sensors, and as conductive additives in polymeric systems.

### SUMMARY

A method for graphitization of carbon-based precursors in the presence of carbon nanotubes comprising supplying carbon nanotubes and supplying a carbon-based precursor composed of up to 15 carbon atoms along with hydrogen atoms. A mixture is formed of the carbon nanotubes and the carbon-based precursor followed by application of selective laser heating to the mixture and graphitizing the carbon-based precursor.

A method for graphitization of carbon-based precursors in the presence of carbon nanotubes comprising supplying carbon nanotubes and supplying a carbon-based precursor composed of up to 15 carbon atoms along with hydrogen atoms. A mixture is formed the carbon nanotubes with the carbon-based precursor wherein said carbon-based precursor is present at a level of 0.1 wt. % to 20.0 wt. % followed by application of selective laser heating to the mixture and graphitizing the carbon-based precursor at a temperature of less than or equal to 800° C.

A method for graphitization of carbon-based precursors in the presence of carbon nanotubes comprising supplying carbon nanotubes and supplying a carbon-based precursor composed of up to 15 carbon atoms along with hydrogen atoms. A mixture if formed of the carbon nanotubes with the carbon-based precursor wherein the carbon-based precursor is present at a level of 0.1 wt. % to 20.0 wt. % followed by application of selective laser heating to the mixture and graphitizing the carbon-based precursor at a temperature of less than or equal to 800° C. with a laser with a power of 20.0 watts to 80.0 watts at a scan rate of 0.5 mm/sec to 20.0 mm/sec and wherein the number of passes are in the range of 1-20.

### DETAILED DESCRIPTION OF PREFERRED EMBODIMENTS

Selective laser heating (SLH) can now be applied to CNT structures, in the presence of carbon-based precursors, to provide extended CNT materials, with improved electrical conductivity. Reference to SLH is the general application of lasers to direct heat to the surface of the CNT/precursor mixture, therefore providing control over the heating profile to be applied. In other words, heating can be directed to a target area so that the remaining area is not exposed to laser heating. As may therefore be appreciated, SLH can be selected to heat layers of CNT/precursor mixtures to create three-dimensional (3D) parts. Preferably, SLH utilized herein employs lasers with a power of 20.0 watts to 80.0 watts, more preferably 30 watts to 60 watts, and most preferably at 30 watts to 50 watts. The scan rate is preferably 0.5 mm/sec to 20.0 mm/sec, or 2.0 mm/sec to 10.0 mm/sec, 2.0 mm/sec to 5.0 mm/sec. The number of passes can fall in the range of 1-20, more preferably 1-10, and most preferably 1-5. The SLH utilized herein also preferably heats the CNTs/precursor mixture to temperature of less than or equal to 800° C., or in a range of 650° C. to 800° C.

As noted above, CNTs herein may be generally understood as hollow cylindrical structures composed of carbon atoms, with diameters measured in nanometers. Preferably, the CNTs that are employed herein are single-walled carbon nanotubes (SWCNTs) where only a single layer of graphene (carbon atoms arranged in a honeycomb planar nanostructure) forms the nanotube structure. The CNTs herein are also contemplated to include double-wall carbon nanotubes (DWCNTs) that are composed of two single-wall carbon nanotubes that are nested in one another. The CNTs herein are preferably sourced from braided carbon nanotube yarn that has a thickness in the range of 100 μm to 10,000 μm, more preferably 100 μm to 5000 μm, and even more preferably 100 μm to 1000 μm. The braided carbon nanotube yarn is preferably sourced from Dexmat (Houston, Texas) as GALVORN™ Carbon Nanotube Braided Yarn. Such braided carbon nanotube yarn reportedly has a density in the range of 0.7 g/cm³ to 1.0 g/cm³, a tensile strength of 0.5 GPa to 1.6 GPa, a thermal conductivity in the range of 200 W/m-K to 300 W/m-K, a Young's Modulus in the range of 50 GPa to 95 GPa, at lengths in the range of 1 m to 10,000 m.

The carbon-based precursors herein are preferably selected from precursors having up to fifteen (15) carbon atoms along with hydrogen atoms. More preferably, the precursors herein have up to ten (10) carbon atoms along with hydrogen atoms. Such precursors may therefore include acyclic as well as cyclic structures and include unsaturated carbon atoms as well as aromatic type structure, and mixtures of such structures. Examples of such preferred carbon-based precursors therefore include benzene (C₆H₆), naphthalene (C₁₀H₈), toluene (C₇H₈), styrene (C₈H₈), and anthracene (C₁₄H₁₀). Acyclic examples include diacetylene (C₄H₂). The precursors are then mixed with the CNTs noted herein at a preferred level in the range of 0.1 wt. % to 20.0 wt. %, more preferably 0.1 wt. % to 10.0 wt. %, and even more preferably, 5.0 wt. % to 10.0 wt. %.

The CNTs in combination with the carbon-based precursors herein are then subjected to SLH. Preferably, it is contemplated that the lasers are adjusted to promote graphitization of the carbon-based precursors without structural decomposition of the CNTs. During graphitization of the carbon-based precursors (i.e. conversion into graphite), it is contemplated that such will then result in the formation of electrical conductive pathways (bridging) between the CNTS with a resulting increase in the observed electrical conductivity. It is also contemplated that the use of SLH is such that it heats at a relatively rapid rate thereby reducing the potential for the carbon-based precursors to undergo evaporation and thereby increasing the formation of bridging between the CNT structures.

1. A method for graphitization of carbon-based precursors in the presence of carbon nanotubes comprising:
a. supplying carbon nanotubes;
b. supplying a carbon-based precursor composed of up to 15 carbon atoms along with hydrogen atoms;
c. forming a mixture of said carbon nanotubes with said carbon-based precursor;
d. applying selective laser heating to said mixture and graphitizing said carbon-based precursor.

2. The method of claim 1, wherein said carbon nanotubes comprise single-wall or double-wall carbon nanotubes.

3. The method of claim 1, wherein said carbon-based precursor contains acyclic structure.

4. The method of claim 1, wherein said carbon-based precursor contains cyclic structures.

5. The method of claim 1, wherein said carbon-based precursor contains unsaturated carbon atoms.

6. The method of claim 1, wherein said carbon-based precursor contains aromatic type structure.

7. The method of claim 1, wherein said carbon-based precursor comprises benzene (C₆H₆).

8. The method of claim 1, wherein said carbon-based precursor comprising naphthalene (C₁₀H₈).

9. The method of claim 1, wherein said carbon-based precursor comprises toluene (C₇H₈).

10. The method of claim 1, wherein said carbon-based precursor comprises styrene (C₈H₈).

11. The method of claim 1, wherein said carbon-based precursor comprises anthracene (C₁₄H₁₀).

12. The method of claim 1, wherein said carbon-based precursor comprises diacetylene (C₄H₂).

13. The method of claim 1, wherein said mixture of carbon-based precursor and carbon nanotubes comprises 0.1 wt. % to 20.0 wt. % of the carbon-based precursor.

14. The method of claim 1, wherein said carbon nanotubes comprises braided carbon nanotube yarn.

15. The method of claim 14, wherein said braided carbon nanotube yarn has a density in the range of 0.7 g/cm³ to 1.0 g/cm³.

16. The method of claim 1, wherein said selective laser heating is provided by a laser with a power of 20.0 watts to 80.0 watts at a scan rate of 0.5 mm/sec to 20.0 mm/sec.

17. The method of claim 1, wherein said selective laser heating heats said mixture to a temperature of less than or equal to 800° C.

18. A method for graphitization of carbon-based precursors in the presence of carbon nanotubes comprising:
a. supplying carbon nanotubes;
b. supplying a carbon-based precursor composed of up to 15 carbon atoms along with hydrogen atoms;
c. forming a mixture of said carbon nanotubes with said carbon-based precursor wherein said carbon-based precursor is present at a level of 0.1 wt. % to 20.0 wt. %; and
d. applying selective laser heating to said mixture and graphitizing said carbon-based precursor at a temperature of less than or equal to 800° C.

19. The method of claim 18, wherein said selected laser heating is provided by a laser with a power of 20.0 watts to 80.0 watts at a scan rate of 0.5 mm/sec to 20.0 mm/sec.

20. A method for graphitization of carbon-based precursors in the presence of carbon nanotubes comprising:
a. supplying carbon nanotubes;
b. supplying a carbon-based precursor composed of up to 15 carbon atoms along with hydrogen atoms;
c. forming a mixture of said carbon nanotubes with said carbon-based precursor wherein said carbon-based precursor is present at a level of 0.1 wt. % to 20.0 wt. %; and
d. applying selective laser heating to said mixture and graphitizing said carbon-based precursor at a temperature of less than or equal to 800° C. with a laser with a power of 20.0 watts to 80.0 watts at a scan rate of 0.5 mm/sec to 20.0 mm/sec and wherein the number of passes are in the range of 1-20.
